(19) United States
(12) Patent Application Publication
(10) Pub. No.: US 2025/0309313 A1
(43) Pub. Date: Oct. 2, 2025

(54) FUEL CELL STACK AND FUEL CELL STACK PRODUCTION METHOD

(71) Applicant: HONDA MOTOR CO., LTD., Tokyo (JP)

(72) Inventors: Yuta OSHIMA, Wako-shi (JP); Kazuma HIROE, Wako-shi (JP); Takuma NOZAKI, Wako-shi (JP)

(21) Appl. No.: 19/064,836

(22) Filed: Feb. 27, 2025

(30) Foreign Application Priority Data
Mar. 29, 2024 (JP) 2024-058304

(51) Int. Cl. H01M 8/2475; H01M 8/2404

(52) U.S. Cl. CPC H01M 8/2475; H01M 8/2404

(57) ABSTRACT

A fuel cell stack includes a multilayered cell, a stack case, and an end unit. The fuel cell stack further includes a shock-absorbing member which is disposed between the stack case and the multilayered cell and which receives an impact relative to the multilayered cell. The shock-absorbing member has an end inserted in the stack case and includes a first step portion at the end of the shock-absorbing member for positioning the shock-absorbing member in a vertical direction with respect to a fastening hole provided in the end unit. The end unit includes a second step portion for positioning the shock-absorbing member in a horizontal direction and the second step portion is in contact with the shock-absorbing member. The fuel cell stack further includes a fastening member, the first step portion engages with the second step portion, and the fastening hole is fastened with the fastening member for positioning the end unit and the shock-absorbing member.

### CROSS REFERENCE TO RELATED APPLICATIONS

This application claims the foreign priority benefit under 35 U.S.C. § 119 of Japanese patent application No. 2024-058304, filed on Mar. 29, 2024, the disclosure of which is incorporated herein by reference.

### BACKGROUND OF THE INVENTION

### 1. Field of the Invention

The present invention relates to a fuel cell stack and a fuel cell stack production method.

### 2. Description of the Related Art

For a conventional fuel cell assembly step, a stack case is provided with positioning guides, whereas each of flat-plate-shaped components constituting a fuel cell are provided with positioning holes. The cell is constituted by sequentially stacking the flat-plate-shaped components by using the positioning holes. Then, there is known a method for constituting a fuel cell stack by repeatedly stacking a desired number of cells.

For example, Abstract of JP2013-196849A discloses “A fuel cell stack assembling method includes: a knock pin arrangement step of arranging a knock pin for positioning unit cells; a stacking step of stacking the unit cells; and a compression step of compressing the unit cells, in which the knock pin includes: a knock pin main body to be arranged in positioning holes of the unit cells after the compression step; and a first extension portion and a second extension portion which are detachably provided to both ends of the knock pin main body, and the fuel cell stack assembling method includes a first extension portion removing step and a second extension portion removing step of, after the compression step, removing the first extension portion and the second extension portion in a state where the unit cells are compressed”.

### CITATION LIST

### Patent Literature

PTL 1: JP2013-196849A

### SUMMARY OF THE INVENTION

In general, a unit cell is composed of a membrane electrode assembly and a pair of separators that sandwich the membrane electrode assembly from both sides. The separators are metal separators made of, for example, steel plates, stainless steel plates, aluminum plates or the like.

For example, in a fuel cell stack, in the case where a guide portion that constitutes the positioning guide is made of a resin, the resin guide portion may be scraped off during work of stacking the metal separators on the guide portion, because the separators come into contact with the guide portion, resulting in a problem of resin powder entering the inside of the fuel cell stack. To avoid this, there has been considered, for example, a method in which a guide portion made of a metal is used during the work of stacking unit cells, and then the metal guide portion is replaced with a resin guide portion after the work of stacking the unit cells is completed.

However, if the guide portion is made of a metal, an electric current generated by each unit cell itself may lead to outside via the stack case. In addition, there may be a case where the fuel cell stack has only an insufficient clearance reserved between the guide portion and the unit cells, which imposes a problem that the resin guide portion may be scraped off by sliding in work of inserting the guide portion into the unit cells.

The present invention was made in view of the foregoing circumstances, and has an object to provide a fuel cell stack and a fuel cell stack production method, which allow a multilayered cell to be arranged inside a stack case while preventing the multilayered cell and a shock-absorbing member from coming into contact with each other.

In response to the above issue, it is an object of the present invention to provide a fuel cell stack including a multilayered cell including power generator cells which are stacked, a stack case in which the multilayered cell is housed, and an end unit disposed at one end of the stack case in a stacking direction. The fuel cell stack further includes a shock-absorbing member which is disposed between the stack case and the multilayered cell and which receives an impact relative to the multilayered cell. The shock-absorbing member has an end inserted in the stack case and includes a first step portion at the end of the shock-absorbing member for positioning the shock-absorbing member in a vertical direction with respect to a fastening hole provided in the end unit. The end unit includes a second step portion for positioning the shock-absorbing member in a horizontal direction and the second step portion is in contact with the shock-absorbing member. The fuel cell stack further includes a fastening member, the first step portion engages with the second step portion, and the fastening hole is fastened with the fastening member for positioning the end unit and the shock-absorbing member.

According to the present invention, it is possible to arrange the multilayered cell inside the stack case while preventing the multilayered cell and the shock-absorbing member from coming into contact with each other.

### BRIEF DESCRIPTION OF THE DRAWINGS

FIG. 1 is an enlarged vertical cross-sectional view showing a part of a fuel cell stack according to a present embodiment.

FIG. 2 is a partially-omitted perspective view of a state where a shock-absorbing member is attached to an end unit.

FIG. 3 is a partially-omitted perspective view of the end unit.

FIG. 4 is a flowchart for explaining a fuel cell stack production method.

FIG. 5 is an explanatory diagram for an end plate mounting step (step S001).

FIG. 6 is an explanatory diagram for a pin placing step (step S003).

FIG. 7 is an explanatory diagram for a stacking step (step S005).

FIG. 8 is an explanatory diagram for a compressing step (step S007).

FIG. 9 is an explanatory diagram for a pin removing step (step S009).

FIG. 10 is an explanatory diagram for a shock-absorbing member inserting step (step S011).

FIG. 11 is an explanatory diagram for a fastening step (step S013).

FIG. 12 is an explanatory diagram showing a modification in which a current collector member and a first insulating member are made slightly smaller than the outer dimensions of a multilayered cell.

### DETAILED DESCRIPTION OF THE EMBODIMENTS

Hereinafter, an embodiment for carrying out the present invention will be described in detail. The embodiment described below is an example for carrying out the present invention, and should be modified or altered as needed depending on the structure of an apparatus and various conditions to which the present invention is applied. The present invention should not be limited to the embodiment described below. Moreover, in the drawings, the same constituent elements will be given the same reference signs and description thereof will be omitted if unnecessary.

### Embodiment

### Structure of Fuel Cell Stack

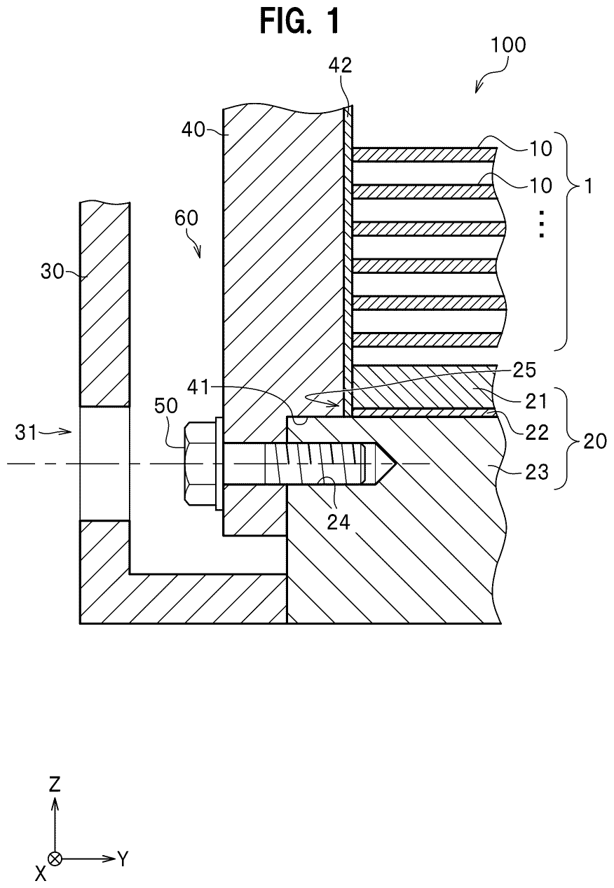

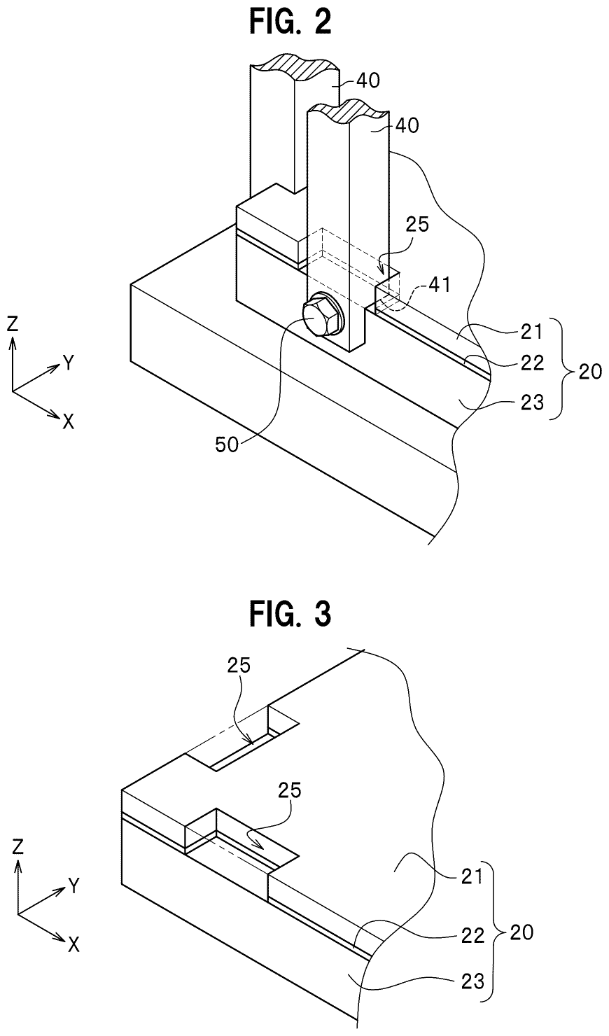

FIG. 1 is an enlarged vertical cross-sectional view showing a part of a fuel cell stack according to a present embodiment. FIG. 2 is a partially-omitted perspective view of a state where a shock-absorbing member is attached to an end unit. FIG. 3 is a partially-omitted perspective view of the end unit.

As shown in FIG. 1, a fuel cell stack 100 according to the present embodiment includes a multilayered cell 1, an end unit 20, and a stack case 30.

The multilayered cell 1 is formed with multiple (a predetermined number of) power generator cells 10 stacked in a Z direction. Each power generator cell 10 is, for example, a solid polymer fuel cell having a rectangular shape with its width (or length) longer in an X direction. The power generator cell 10 mainly includes a membrane electrode assembly (not shown) and a pair of separators (not shown) arranged on both sides of the membrane electrode assembly (both sides in the Z direction).

Each of the separators also has a rectangular shape with its width (or length) longer in the X direction, as in the power generator cell 10. The separator is made of, for example, a steel plate, a stainless steel plate, an aluminum plate, a plated steel plate, a metal plate whose metal surface treated for corrosion prevention, or a carbon member.

Including the aforementioned multilayered cell 1 in which the power generator cells 10 are stacked, the fuel cell stack 100 is mounted on a fuel cell vehicle.

The multilayered cell 1 is housed in the stack case 30 in FIG. 1. The end unit 20 is arranged at one end of the stack case 30 in a stacking direction (−Z direction).

The end unit 20 includes a current collector member 21, a first insulating member 22 (insulator), and an end plate 23. As shown in FIG. 1, the end unit 20 is constituted with the above members stacked in the −Z direction from the multilayered cell 1 side in the aforementioned order.

In the fuel cell stack 100, at the other end of the multilayered cell 1 in the stacking direction (+Z direction), another current collector member 21, another first insulating member 22, and another end plate 23 are similarly staked in this order in the +Z direction.

In other words, the pair of the end plates 23 and 23 in the fuel cell stack 100 are located on both sides of the multilayered cell 1 in the stacking direction (Z direction) of the multilayered cell 1. The pair of the current collector members 21 and 21 and the pair of the first insulating members 22 and 22 are similarly located on both sides of the multilayered cell 1 in the stacking direction (Z direction) of the multilayered cell 1.

The end plate 23 is made of a metal and has a rectangular shape with its width (or length) longer in the X direction. The end plate 23 includes a fastening hole 24.

As shown in FIG. 1, the fuel cell stack 100 includes a shock-absorbing member 40 between the stack case 30 and the multilayered cell 1 that receives an impact relative to the multilayered cell 1. The shock-absorbing member 40 includes, for example, a second insulating member, such as an insulator.

As shown in FIGS. 1 and 2, the shock-absorbing member 40 is in contact with the multilayered cell 1 in a Y direction for positioning the multilayered cell 1. The shock-absorbing member 40 includes, for example, a resin. An elastic member 42 is attached to a surface of the shock-absorbing member 40 and is in contact with the multilayered cell 1. A first step portion 41 is provided at an end of the shock-absorbing member 40 to be inserted in the −Z direction. The first step portion 41 of the shock-absorbing member 40 positions the shock-absorbing member 40 in the vertical direction with respect to the fastening hole 24 provided in the end plate 23 of the end unit 20.

As shown in FIGS. 1 to 3, the end unit 20 includes a second step portion 25 which is in contact with the shock-absorbing member 40. The second step portion 25 of the end unit 20 positions the shock-absorbing member 40 in a horizontal direction. The second step portion 25 is formed such that the second step portion 25 extends from the end plate 23 through the current collector member 21 and the first insulating member 22.

In the fuel cell stack 100, when the shock-absorbing member 40 is inserted between the stack case 30 and the multilayered cell 1 as shown in FIG. 1, the first step portion 41 of the shock-absorbing member 40 engages with the second step portion 25 of the end unit 20 as shown in FIG. 2.

The stack case 30 includes a through hole 31 as shown in FIG. 1. In the stack case 30, a fastening member 50 is inserted through the through hole 31 toward the end plate 23. The fastening member 50 fastens the shock-absorbing member 40 to the fastening hole 24 of the end plate 23. In the fuel cell stack 100, the fastening hole 24 is fastened with the fastening member 50 for positioning the end unit 20 and the shock-absorbing member 40.

In the present embodiment, a clearance 60 is provided between the stack case 30 and the shock-absorbing member 40. The clearance 60 is adjustable with the fastening member 50.

### Fuel Cell Stack Production Method

Next, an outline of a production method of producing the fuel cell stack 100 by using an assembly apparatus 200 will be described in reference to a flowchart. As the method of producing the fuel cell stack 100, there are a method of stacking the power generator cells 10 inside the stack case 30 and a method of first stacking the power generator cells 10 and then fixing the multilayered cell 1 to the stack case 30. In the present embodiment, an outline of the method of stacking the power generator cells 10 inside the stack case 30 will be described as an example.

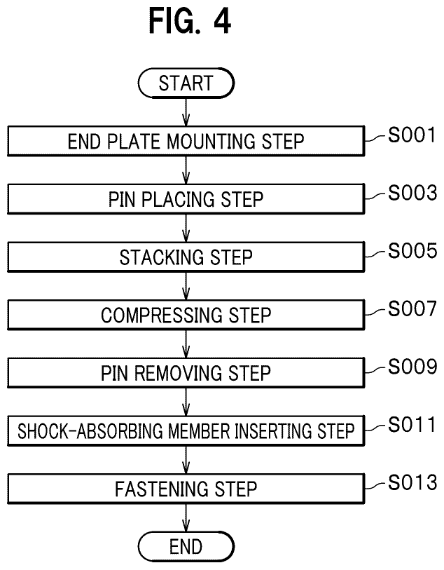

FIG. 4 is a flowchart for explaining the method of producing the fuel cell stack 100. As shown in FIG. 4, the method of producing the fuel cell stack 100 includes: an end plate mounting step (step S001), a pin placing step (step S003), a stacking step (step S005), a compressing step (step S007), a pin removing step (step S009), a shock-absorbing member inserting step (step S011), and a fastening step (step S013).

The present embodiment has features particularly in the shock-absorbing member inserting step in step S011 and the fastening step in step S013. Hereinafter, each of the steps will be described.

In the end plate mounting step (step S001) in FIG. 4, first, a pair of end plates 23 (end plates 23a and 23b) are mounted on a base plate 201 and a movable plate 206, respectively.

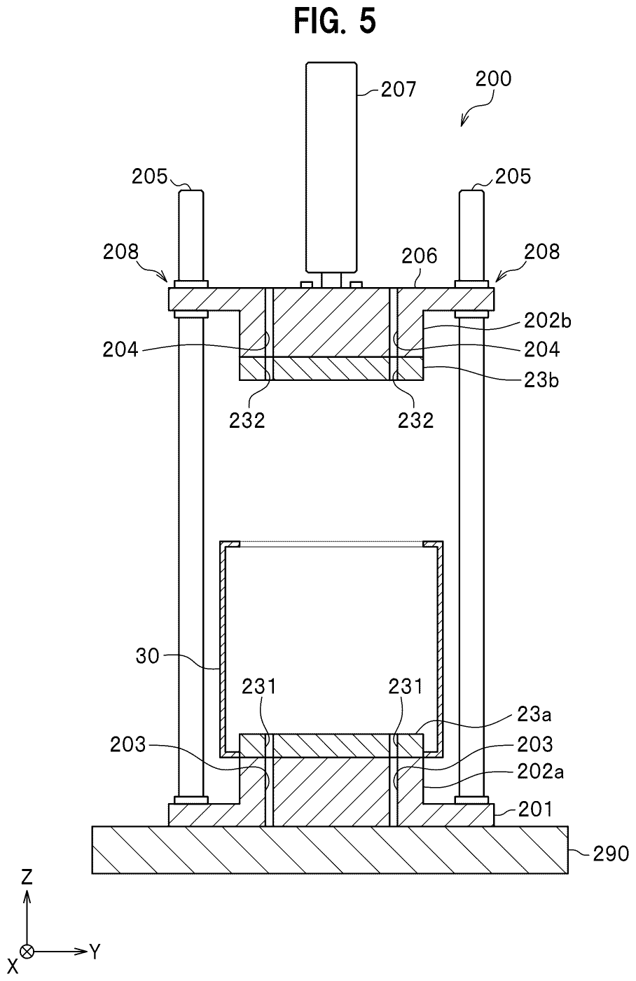

FIG. 5 is an explanatory diagram for the end plate mounting step (step S001). As shown in FIG. 5, the assembly apparatus 200 is installed on a surface plate 290. The assembly apparatus 200 mainly includes the base plate 201, multiple frames 205, the movable plate 206, and a hydraulic cylinder 207.

The base plate 201 is formed in a substantially rectangular shape with outer dimensions larger than those of the fuel cell stack 100 as viewed in the Z direction. The base plate 201 includes a step portion 202a protruding in the Z direction. In the step portion 202a, pin insertion holes 203 are formed. The movable plate 206 is arranged on the multiple frames 205 in the Z direction.

The movable plate 206 is formed in a shape approximately plane symmetrical to the base plate 201. The movable plate 206 is formed in a substantially rectangular shape with outer dimensions larger than those of the fuel cell stack 100 as viewed in the Z direction. In the four corners of the movable plate 206, frame insertion holes 208 passing through the movable plate 206 in the Z direction are formed. The movable plate 206 is slidable in the Z direction, which is an extending direction of the frames 25. The movable plate 206 also includes a step portion 202b protruding in the −Z direction (inward direction). In the step portion 202b, pin insertion holes 204 are formed.

In the end plate mounting step (step S001) in FIG. 4, the end plate 23a is mounted on the step portion 202a of the base plate 201. Meanwhile, the end plate 23b is mounted on the step portion 202b of the movable plate 206. The mounting is performed with, for example, bolts (not shown) or the like fastened.

Positioning holes 231 are formed in the end plate 23a and positioning holes 232 are formed in the end plate 23b. The stack case 30 for stacking the power generator cells 10 is attached to the end plate 23a. The end plate 23a and the stack case 30 are fastened to each other with, for example, bolts (not shown) or the like fastened. In this way, a bottom portion of the stack case 30 is formed by the end plate 23a.

Accordingly, when the end plate 23a to which the stack case 30 is attached is mounted on the base plate 201 and the end plate 23b is mounted on the movable plate 206, the end plate mounting step (step S001) is terminated. Instead, for example, after the end plate 23a is mounted on the base plate 201, the stack case 30 may be fastened and attached to the end plate 23a.

Returning to FIG. 4, the description will be continued.

In the pin placing step (step S003) in FIG. 4, knock pins are placed in the assembly apparatus 200.

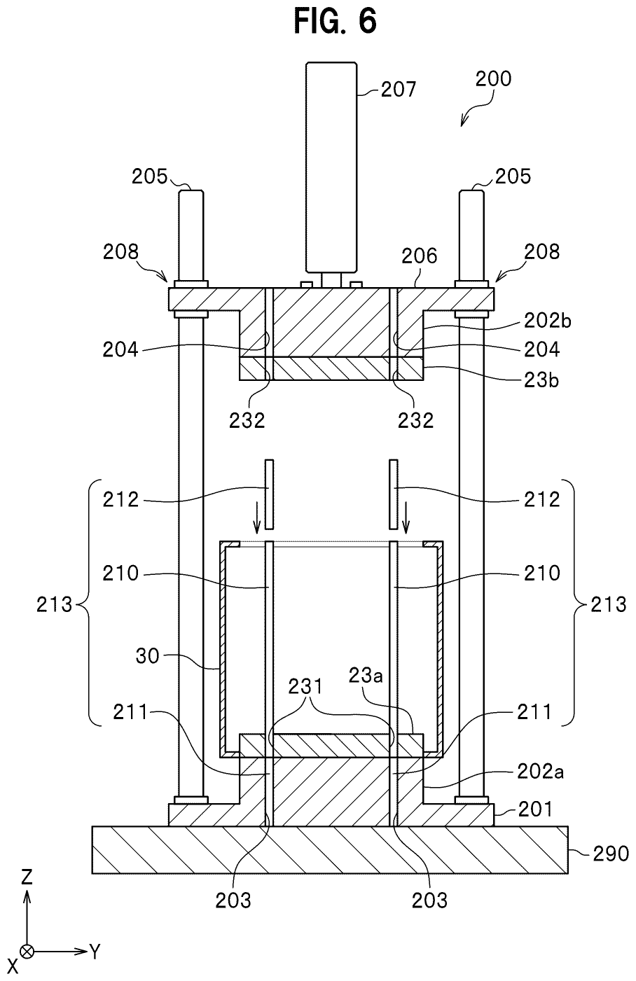

FIG. 6 is an explanatory diagram for the pin placing step (step S003). As shown in FIG. 6, in the assembly apparatus 200, first extension portions 211 are attached to knock pin main bodies 210, and then the first extension portions 211 are inserted into the pin insertion holes 203 of the step portion 202a. Meanwhile, second extension portions 212 are attached to the knock pin main bodies 210.

Each knock pin 213 includes the knock pin main body 210, the first extension portion 211, and the second extension portion 212. The assembly apparatus 200 terminates the pin placing step (step S003) when the first extension portions 211 are placed in the step portion 202a of the assembly apparatus 200 and the knock pins 213 are formed by the knock pin main bodies 210, the first extension portions 211, and the second extension portions 212.

Returning to FIG. 4, the description will be continued.

In the stacking step (step S005) in FIG. 4, members including the first insulating members 22a and 22b, the current collector members 21a and 21b, the power generator cells 10 are stacked.

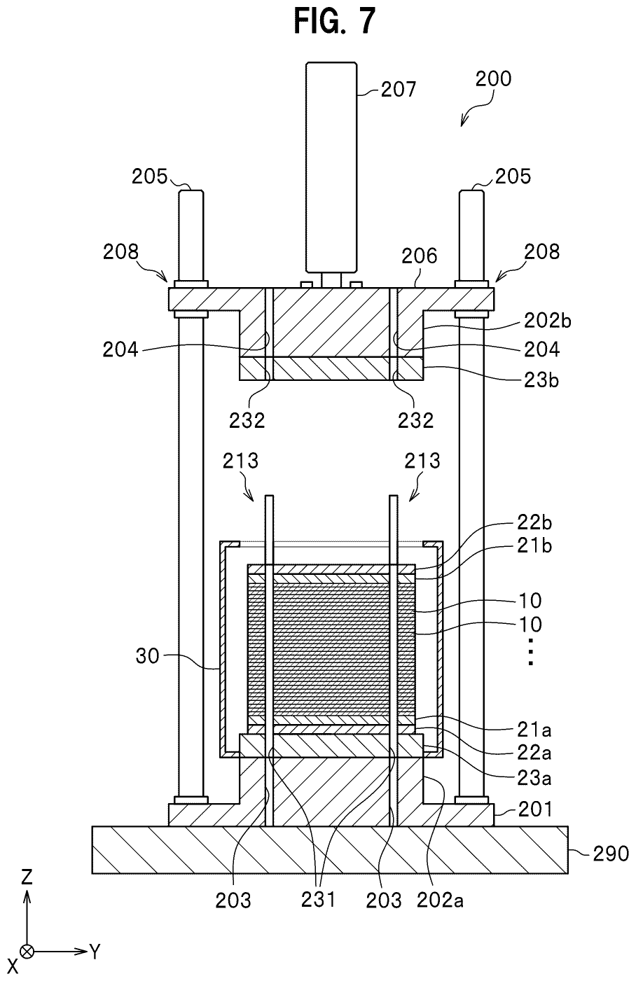

FIG. 7 is an explanatory diagram for the stacking step (step S005). As shown in FIG. 7, the assembly apparatus 200 stacks the first insulating member 22a, the current collector member 21a, the power generator cells 10, the current collector member 21b, and the first insulating member 22b on the end plate 23a in this order.

In this process, the assembly apparatus 200 performs the stacking while inserting the knock pins 213 into positioning holes (similar to the positioning holes 231 of the end plate 23) of the members including the first insulating members 22a and 22b, the current collector members 21a and 21b, and the power generator cells 10. The assembly apparatus 200 terminates the stacking step (step S005) when the first insulating members 22a and 22b, the current collector members 21a and 21b, and the power generator cells 10 are stacked.

Returning to FIG. 4, the description will be continued.

In the compressing step (step S007) in FIG. 4, the stacked members including the first insulating members 22a and 22b, the current collector members 21a and 21b, and the power generator cells 10 are compressed.

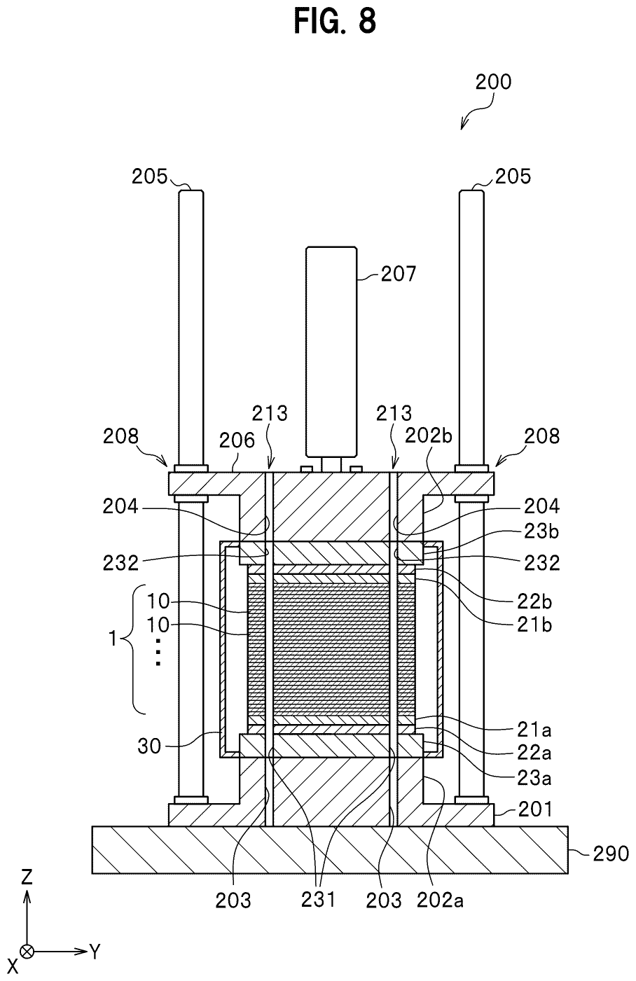

FIG. 8 is an explanatory diagram for the compressing step (step S007). As shown in FIG. 8, the assembly apparatus 200 operates the hydraulic cylinder 207 to move the movable plate 206 and the end plate 23b in the −Z direction.

In this process, the knock pins 213 are inserted into the positioning holes 232 of the end plate 23b and the pin insertion holes 204 of the movable plate 206. This allows the end plate 23b to be positioned in the XY directions with high precision.

In addition, the assembly apparatus 200 further moves the movable plate 206 and the end plate 23b in the −Z direction and compresses the stacked members including the first insulating members 22a and 22b, the current collector members 21a and 21b, and the power generator cells 10 by applying a predetermined load thereto. When the members including the first insulating members 22a and 22b, the current collector members 21a and 21b, and the power generator cells 10 are compressed and the multilayered cell 1 is formed of the power generator cells 10, the compressing step (step S007) is terminated.

Returning to FIG. 4, the description will be continued.

In the pin removing step (step S009) in FIG. 4, the assembly apparatus 200 removes the knock pins 213 from the multilayered cell 1.

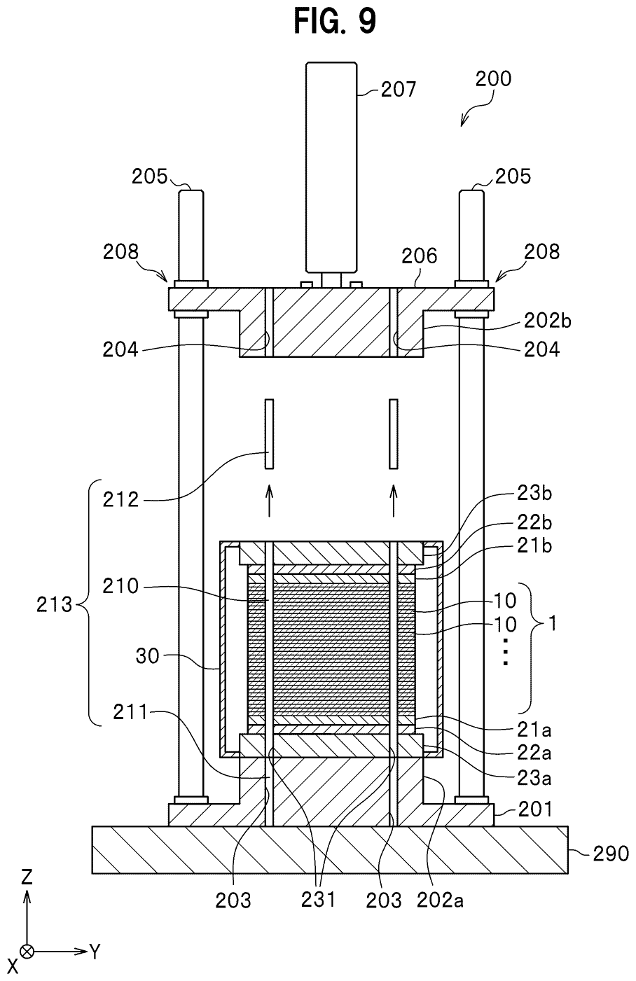

FIG. 9 is an explanatory diagram for the pin removing step (step S009). As shown in FIG. 9, the assembly apparatus 200 removes the knock pins 213 (the knock pin main bodies 210, the first extension portions 211, and the second extension portions 212) from the compressed members including the end plates 23a and 23b, the first insulating members 22a and 22b, the current collector members 21a and 21b, and the multilayered cell 1 (the power generator cells 10).

In this case, the assembly apparatus 200 operates the hydraulic cylinder 207 to slide the movable plate 206 in the Z direction. Then, the assembly apparatus 200 removes the second extension portions 212, the knock pin main bodies 210, and the first extension portions 211 in this order from the compressed members including the end plates 23a and 23b, the first insulating members 22a and 22b, the current collector members 21a and 21b, and the multilayered cell 1 (the power generator cells 10).

The assembly apparatus 200 may attach, for example, tie rods (not shown) to the compressed members including the first insulating members 22a and 22b, the current collector members 21a and 21b, and the multilayered cell 1 (the power generator cells 10) to remove the knock pins 213 (the knock pin main bodies 210, the first extension portions 211, and the second extension portions 212). The assembly apparatus 200 terminates the pin removing step (step S009) when the knock pins 213 are removed.

Returning to FIG. 4, the description will be continued.

In the shock-absorbing member inserting step (step S011) in FIG. 4, the shock-absorbing member 40 is inserted between the stack case 30 and the multilayered cell 1.

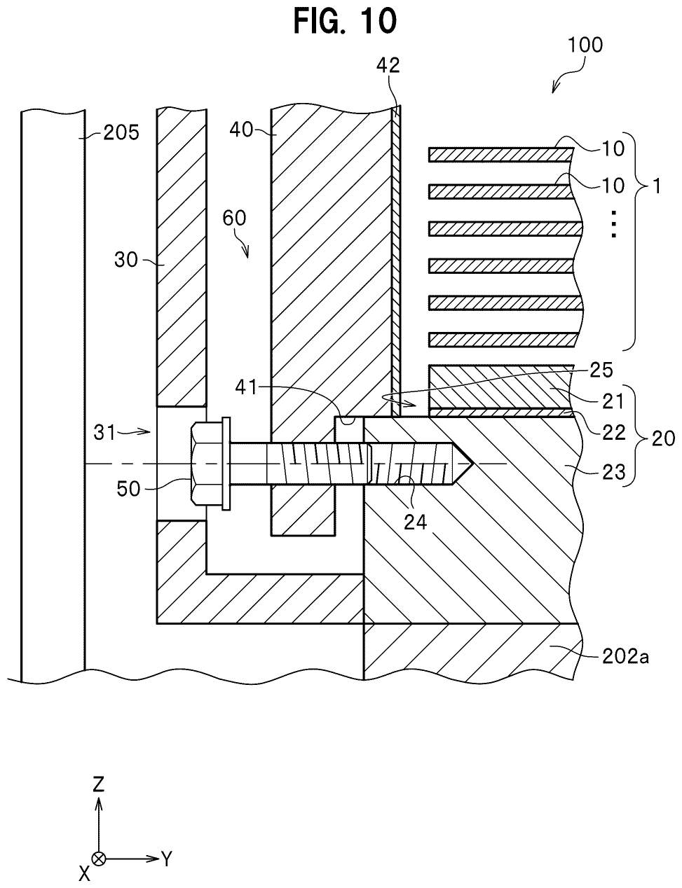

FIG. 10 is an explanatory diagram for the shock-absorbing member inserting step (step S011). As shown in FIG. 10, the assembly apparatus 200 inserts the shock-absorbing member 40 with the fastening member 50 attached thereto between the stack case 30 and the multilayered cell 1.

In this process, since the clearance 60 is provided between the stack case 30 and the shock-absorbing member 40, the assembly apparatus 200 inserts the shock-absorbing member 40 while biasing the shock-absorbing member 40 toward the stack case 30 so that the shock-absorbing member 40 may be kept out of contact with the multilayered cell 1. Here, the fastening member 50 is attached to the shock-absorbing member 40 for the purpose of preliminary fastening. The assembly apparatus 200 terminates the shock-absorbing member inserting step (step S011) when the shock-absorbing member 40 is inserted as described above.

Returning to FIG. 4, the description will be continued.

In the fastening step (step S013) in FIG. 4, the first step portion 41 and the second step portion 25 are engaged with each other and then fastened with the fastening member 50.

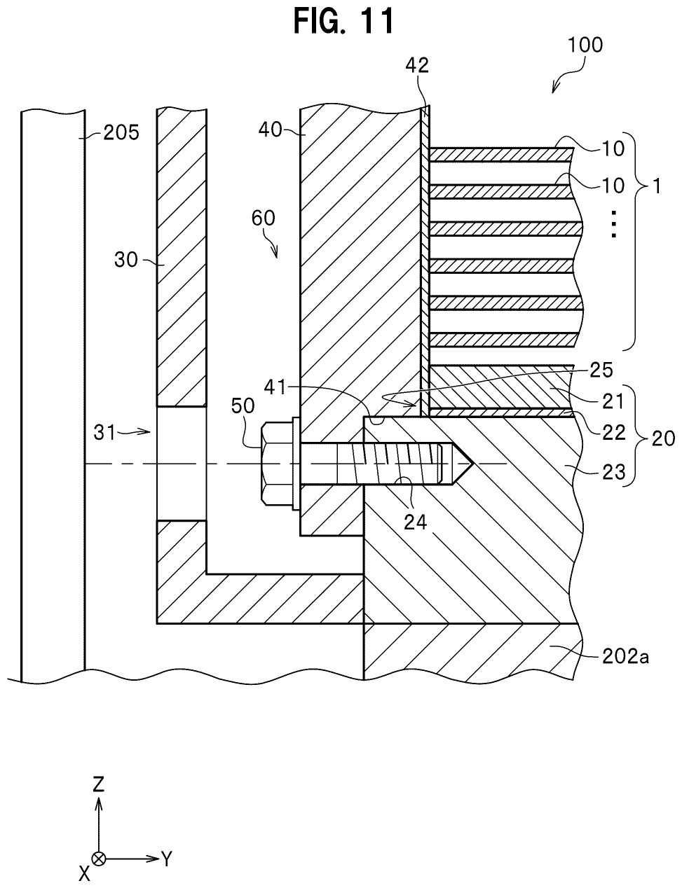

FIG. 11 is an explanatory diagram for the fastening step (step S013). As shown in FIG. 11, the assembly apparatus 200 engages the first step portion 41 of the shock-absorbing member 40 with the second step portion 25 of the end unit 20 and fastens the shock-absorbing member 40 to the fastening hole 24 by using the fastening member 50. In this case, the assembly apparatus 200 positions the end unit 20 and the shock-absorbing member 40. As a result, the clearance 60 between the stack case 30 and the shock-absorbing member 40 is set as appropriate and the elastic member 42 of the shock-absorbing member 40 is brought into contact with the multilayered cell 1.

When the assembly apparatus 200 finishes positioning the end unit 20 and the shock-absorbing member 40 (step S013), the fuel cell stack 100 in which the multilayered cell 1 is attached to the stack case 30 is removed from the assembly apparatus 200, and the flowchart in FIG. 4 is terminated.

As described above, the fuel cell stack 100 according to the present embodiment includes the multilayered cell 1 including the power generator cells 10 which are stacked, the stack case 30 in which the multilayered cell 1 is housed, and the end unit 20 disposed at one end of the stack case 30 in the stacking direction. The fuel cell stack 100 further includes the shock-absorbing member 40 which is disposed between the stack case 30 and the multilayered cell 1 and which receives an impact relative to the multilayered cell 1. The shock-absorbing member 40 has the end inserted in the stack case 30 and includes the first step portion 41 at the end of the shock-absorbing member 40 for positioning the shock-absorbing member 40 in a vertical direction with respect to a fastening hole 24 provided in the end unit 20. The end unit 20 includes the second step portion 25 for positioning the shock-absorbing member 40 in a horizontal direction and the second step portion 25 is in contact with the shock-absorbing member 40. The fuel cell stack 100 further includes the fastening member 50, the first step portion 41 engages with the second step portion 25, and the fastening hole 24 is fastened with the fastening member 50 for positioning the end unit 20 and the shock-absorbing member 40.

With this structure, the fuel cell stack 100 according to the present embodiment makes it possible to engage the first step portion 41 of the shock-absorbing member 40 with the second step portion 25 of the end unit 20. In addition, in the fuel cell stack 100, the end unit 20 and the shock-absorbing member 40 can be positioned with the fastening member 50 inserted through the through hole 31 of the stack case 30.

Thus, in the fuel cell stack 100 according to the present embodiment, the shock-absorbing member 40 can be attached to the multilayered cell 1 from outside thereof, which makes it possible to arrange the multilayered cell 1 inside the stack case 30 while avoiding a situation where resin powers enter the inside of the fuel cell stack 100 in the course of attaching the shock-absorbing member 40.

Moreover, the end unit 20 may include the current collector member 21, the first insulating member 22, and the end plate 23 layered in this order, and the current collector member 21 may be closer to the multilayered cell 1 than the first insulating member 22. The shock-absorbing member 40 may include the second insulating member, and the second step portion 25 may be formed such that the second step portion 25 extends from the end plate 23 through the current collector member 21 and the first insulating member 22.

With this structure, in the fuel cell stack 100 according to the present embodiment, both end portions of the multilayered cell 1 in the Z direction may be each formed with the current collector member 21, the first insulating member 22, and the end plate 23 layered in this order and the current collector member 21 closer to the multilayered cell 1 than the first insulating member 22. Moreover, in the fuel cell stack 100, since the first step portion 41 of the shock-absorbing member 40 can be fastened to the second step portion 25 formed such that the second step portion 25 extends from the end plate 23 through the current collector member 21 and the first insulating member 22, the shock-absorbing member 40 and the end unit 20 can be joined firmly.

Further, in the fuel cell stack 100 according to the present embodiment, the shock-absorbing member 40 may include a resin. The elastic member 42 may be attached to the surface of the shock-absorbing member 40 and may be in contact with the multilayered cell 1.

With this structure, in which the shock-absorbing member 40 is in contact with the multilayered cell 1, the fuel cell stack 100 according to the present embodiment is capable of preventing the multilayered cell 1 from displacing even when a sharp load variation such as an impact occurs on the stack case 30. As a result, the fuel cell stack 100 according to the present embodiment is provided with resistance to impact.

Furthermore, in the fuel cell stack 100 according to the present embodiment, the clearance 60 is provided between the stack case 30 and the shock-absorbing member 40 and the clearance 60 may be adjusted by using the fastening member 50.

With this structure, the fuel cell stack 100 according to the present embodiment makes it possible to adjust the clearance 60 by using the fastening member 50. Thus, a margin against external impacts can be established in the fuel cell stack 100 according to the present embodiment, which makes it possible to prevent the fuel gas in the power generator cells 10 from leaking due to an impact, thereby ensuring the function and safety of the multilayered cell 1.

The method of producing the fuel cell stack 100 is the method of producing the fuel cell stack 100 which includes the multilayered cell 1, the stack case 30, and the end unit 20, and which may further include the shock-absorbing member 40. The shock-absorbing member 40 is provided with the first step portion 41, while the end unit 20 is provided with the second step portion 25. Thus, in the method of producing the fuel cell stack 100, the shock-absorbing member inserting step (step S011) and the fastening step (step S013) can be executed.

Additionally, in the method of producing the fuel cell stack 100, the shock-absorbing member 40 and the multilayered cell 1 may be brought into contact with each other and the clearance 60 may be adjusted by fastening the fastening member 50 in the fastening step (step S013).

### Modification

In the fuel cell stack 100 according to the present embodiment, the end unit 20 is provided with the second step portion 25 at the position to be in contact with the shock-absorbing member 40 for positioning the shock-absorbing member 40 in the horizontal direction, but the structure is not limited to this.

For example, in FIGS. 1 and 11 showing the present embodiment, the second step portion 25 is formed such that the second step portion 25 extends from the end plate 23 through the current collector member 21 and the first insulating member 22. Instead, the current collector member 21 and the first insulating member 22 may be located at the same positions as the second step portions 25 in the X and Y directions of the shock-absorbing members 40.

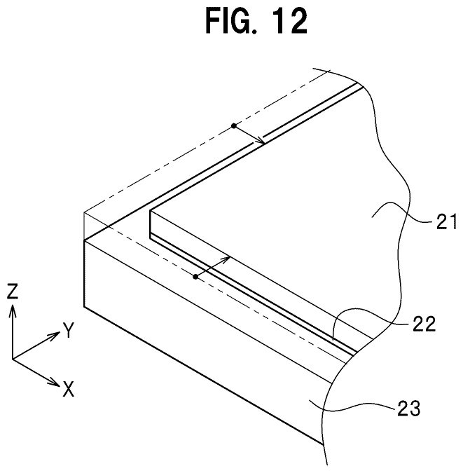

FIG. 12 is an explanatory diagram showing a modification in which a current collector member and a first insulating member are made slightly smaller than the outer dimensions of a multilayered cell. As shown in FIG. 12, in the modification of the present embodiment, the entire peripheries of the current collector member 21 and the first insulating member 22 can be located at the same positions as the second step portions 25.

As a result, the current collector member 21 and the first insulating member 22 in the end unit 20 can be made slightly smaller than the outer dimensions of the multilayered cell 1, which makes it possible to achieve downsizing and weight reduction of the fuel cell stack 100.

It is understood that the foregoing description is that of the preferred embodiments of the invention and that various changes and modifications may be made thereto without departing from the spirit and scope of the invention as defined in the appended claims.

What is claimed is:

1. A fuel cell stack comprising:
a multilayered cell including power generator cells which are stacked;
a stack case in which the multilayered cell is housed; and
an end unit disposed at one end of the stack case in a stacking direction;
wherein the fuel cell stack further comprising a shock-absorbing member which is disposed between the stack case and the multilayered cell and which is configured to receive an impact relative to the multilayered cell;
wherein the shock-absorbing member has an end inserted in the stack case and includes a first step portion at the end of the shock-absorbing member for positioning the shock-absorbing member in a vertical direction with respect to a fastening hole provided in the end unit;
wherein the end unit includes a second step portion for positioning the shock-absorbing member in a horizontal direction and the second step portion is in contact with the shock-absorbing member; and
wherein the fuel cell stack further comprising a fastening member, the first step portion engages with the second step portion, and the fastening hole is fastened with the fastening member for positioning the end unit and the shock-absorbing member.

2. The fuel cell stack according to claim 1, wherein the end unit includes: a current collector member; a first insulating member; and an end plate;
wherein the current collector member, the first insulating member, and the end plate are layered in this order, and the current collector member is closer to the multilayered cell than the first insulating member;
wherein the shock-absorbing member includes a second insulating member; and
wherein the second step portion is formed such that the second step portion extends from the end plate through the current collector member and the first insulating member.

3. The fuel cell stack according to claim 1, wherein the fuel cell stack further comprising an elastic member which is attached to a surface of the shock-absorbing member and which is in contact with the multilayered cell; and
wherein the shock-absorbing member includes a resin.

4. The fuel cell stack according to claim 1, wherein the fuel cell stack has a clearance between the stack case and the shock-absorbing member; and
wherein the clearance is adjustable with the fastening member.

5. A method of producing a fuel cell stack, comprising:
inserting a shock-absorbing member between a stack case and a multilayered cell;
engaging a first step portion with a second step portion; and
fastening the shock-absorbing member to a fastening hole by using a fastening member;
wherein the fuel cell stack includes: the multilayered cell including power generator cells which are stacked; the stack case in which the multilayered cell is housed; and an end unit disposed at one end of the stack case in a stacking direction;
wherein the fuel cell stack further includes the shock-absorbing member configured to receive an impact relative to the multilayered cell;
wherein the shock-absorbing member has an end inserted into the stack case and includes the first step portion at the end of the shock-absorbing member for positioning the shock-absorbing member in a vertical direction with respect to the fastening hole provided in the end unit; and
wherein the end unit includes the second step portion for positioning the shock-absorbing member in a horizontal direction and the second step portion is in contact with the shock-absorbing member.

6. The method according to claim 5, wherein the fastening includes: bringing the shock-absorbing member and the multilayered cell into contact with each other by fastening the fastening member; and adjusting a clearance; and
wherein the clearance is disposed between the stack case and the shock-absorbing member.

7. The fuel cell stack according to claim 2, wherein the fuel cell stack further comprising an elastic member which is attached to a surface of the shock-absorbing member and which is in contact with the multilayered cell; and
wherein the shock-absorbing member includes a resin.
